(19) United States
(12) Patent Application Publication
(10) Pub. No.: US 2020/0053223 A1
(43) Pub. Date: Feb. 13, 2020

(54) ADJUSTING OF COMMUNICATION MODE

(71) Applicant: International Business Machines Corporation, Armonk, NY (US)

(72) Inventors: Fang Lu, Billerica, MA (US); Nadiya Kochura, Bolton, MA (US)

(21) Appl. No.: 16/056,978

(22) Filed: Aug. 7, 2018

(51) Int. Cl. H04M 7/00; H04L 12/58; H04L 29/08; G10L 15/22; G10L 15/18; G10L 25/63; G06K 9/00

(52) U.S. Cl. CPC H04M 7/0012; H04L 51/36; H04L 67/306; G06K 9/00228; G10L 15/1815; G10L 25/63; G10L 15/22

(57) ABSTRACT

Methods, systems, and computer program products are provided. A computing device identifies a first communication mode being used by a user to communication with at least one other user. The computing device analyzes the communication effectiveness between the user and the at least one other user based, at least partly, on determining a sentiment and an emotional state of the user. The computing device determines a second communication mode available to the user and the at least one other user that is more effective than the first communication mode based on the analyzing. The first communication mode is then switched to the second communication mode and a summary of communications between the user and the at least one other user is provided via the second communication mode.

### BACKGROUND

### 1. Technical Field

Present invention embodiments relate to a computer system, a method and a computer program product for evaluating an effectiveness of communications between users via a current communication mode and switching to a more effective communication mode.

### 2. Discussion of the Related Art

Today's modes of communication include, but are not limited to, telephone calls, video chats, instant messaging and emails. Nearly everyone seems to have a busy schedule and a busy life. As a result, many people have only limited opportunities to communicate and may sometimes communicate via a less than ideal mode of communication, which could result in misunderstandings, increased stress levels and discomfort for communicating users.

### SUMMARY

According to an aspect of embodiments of the invention, a computer-implemented method is provided. A computing device identifies a first communication mode being used by a user to communicate with at least one other user. The computing device analyzes communication effectiveness between the user and the at least one other user based, at least partly, on determining a sentiment and an emotional state of the user. The computing device determines a second communication mode available to the user and the at least one other user that is more effective than the first communication mode based on the analyzing. The first communication mode is then switched to the second communication mode. The computing device provides a summarized version of communications between the user and the at least one other user via the second communication mode.

According to another aspect of the embodiments of the invention, a computer system is provided. The computer system includes at least one processor and a memory connected to the at least one processor. The memory has recorded therein instructions, such that when the at least one processor executes the instructions, a first communication mode being used by a user to communicate with at least one other user is identified. Communication effectiveness between the user and the at least one other user is analyzed based, at least partly, on determining a sentiment and an emotional state of the user. A second communication mode available to the user and the at least one other user that is more effective than the first communication mode is determined based on the analyzing. The current communication mode is then switched to the second communication mode and a summarized version of communications between the user and the at least one other user is provided via the second communication mode.

According to yet another aspect of the embodiments of the invention, a computer program product is provided that includes at least one computer readable storage medium having computer readable program code embodied therewith for execution on at least one processor of a computing device. The computer readable program code is configured to be executed by the at least one processor to identify a first communication mode being used by a user to communicate with at least one other user. Communication effectiveness between the user and the at least one other user is analyzed based, at least partly, on determining a sentiment and an emotional state of the user. A second communication mode available to the user and the at least one other user that is more effective than the first communication mode is determined based on the analyzing. The first communication mode is then switched to the second communication mode and a summarized version of communications between the user and the at least one other user is provided via the second communication mode.

### BRIEF DESCRIPTION OF THE DRAWINGS

Generally, like reference numerals in the various figures are utilized to designate like components.

FIG. 1 illustrates an example environment in which embodiments of the invention may operate.

FIG. 2 is a functional block diagram of a computer system that may implement a user processing device or a server according to embodiments of the invention.

FIG. 3 is a flowchart that illustrates example overall processing according to embodiments of the invention.

FIG. 4 is a flowchart that illustrates example processing for determining a sentiment and an emotional state of users according to embodiments of the invention.

FIG. 5 is a flowchart of an example process for computing a communication effectiveness score of a current communication mode according to embodiments of the invention.

### DETAILED DESCRIPTION

In various embodiments, a computer system, a method, and a computer program product are provided for evaluating an effectiveness of communications between users via a current communication mode and recommending or switching to a more effective communication mode when one is available.

A computing device may identify a current communication mode used to communicate between a user and at least one other user and at least one other communication mode available to the communicating users. Communication modes may include, but not be limited to, email, video chats, text messages and phone calls. During a communication session, users' sentiments and emotional states may be determined. For example, users' facial images may be captured and the facial images may be classified to determine the sentiments and emotional states of the users participating in the communication session. In some embodiments, user communication devices may include sensors to detect whether a user's hand is shaking while providing textual input for the communication. In other embodiments, an image capturing device may be included in user communication devices to capture video images of a user's hands to determine whether the user's hands shake when providing textual input. When a user provides voice input for a communication, a determination may be made regarding whether a user stutters. Whether a user's hands shake and/or whether a user stutters are factors that may be considered when determining the sentiment and emotional state of the user.

In some embodiments, natural language processing of communications between users may determine a subject matter of the communication and may determine whether a user understands the communication. A user's level of understanding of communications may be determined based on an appropriateness of the user's communications in view of related communications from one or more other users.

In some embodiments, historical information with respect to one or more communicating users may be considered when determining communication effectiveness of communications.

Other features may be included in various embodiments of the invention and will be described in detail below.

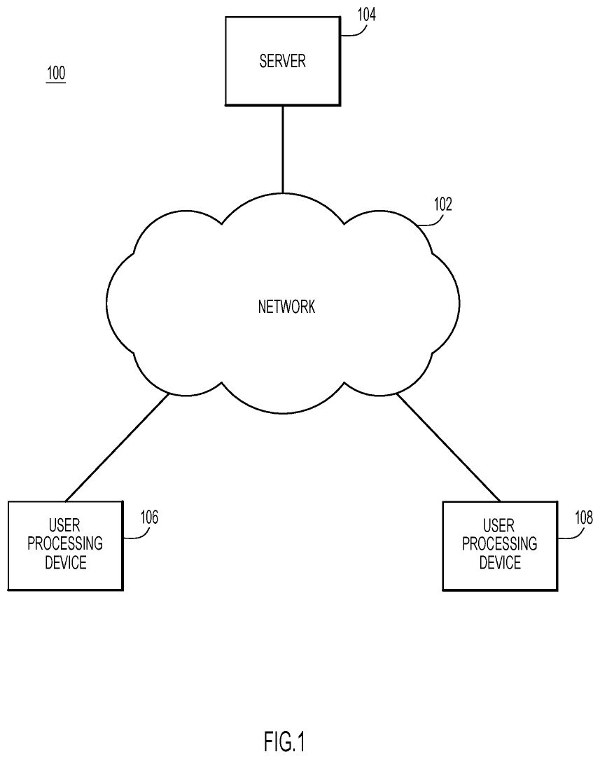

FIG. 1 illustrates an example environment 100 in which embodiments of the invention may operate. Example environment 100 may include a network 102 to which are connected, via a wired or a wireless connection, a number of user processing devices such as, for example, user processing device 106, user processing device 108, and a server 104.

User processing devices 106, 108 may include, but not be limited to, a smartphone, a tablet computer, a laptop computer or notebook computer, a desktop computer, a mainframe computer, or other type of computer. User processing devices 106, 108 may communicate with each other or with other user processing devices (not shown) via network 102. Information may be collected by user processing devices 106, 108 and used to determine sentiments and emotional states of users. The information may be processed by each of user processing devices 106, 108, may be processed by server 104, or may be processed by a combination of user processing devices 106, 108 and server 104.

Server 104 may include, but not be limited to, a desktop computer, a laptop computer, a mainframe computer, or other type of computer or may include a number of computers configured as a server farm.

Network 102 may be implemented by any number of any suitable communications media, such as a wide area network (WAN), local area network (LAN), Internet, Intranet, etc.) or a combination of any of the suitable communications media. Network 102 may further include wired and/or wireless networks.

Although FIG. 1 shows only user processing devices 106, 108, a number of user processing devices may be connected to and communicate with each other via network 102.

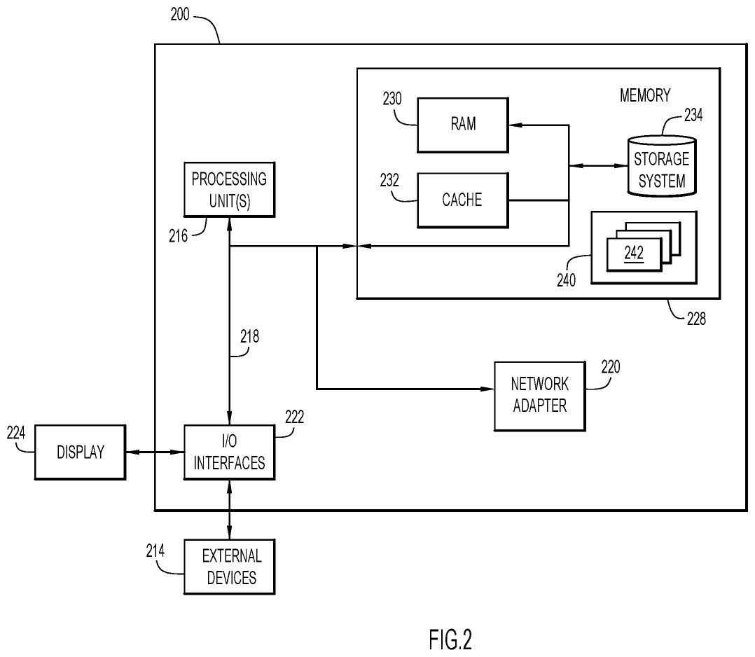

Referring now to FIG. 2, a schematic of an example computer system 200 is shown. Computer system 200 may implement user processing device 106 or 108, or server 104. Computer system 200 is shown in a form of a general-purpose computing device. Components of computer system 200 may include, but are not limited to, one or more processors or processing units 216, a system memory 228, and a bus 218 that couples various system components including system memory 228 to one or more processing units 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 200 may include a variety of computer system readable media.

Such media may be any available media that is accessible by computer system 200, and may include both volatile and non-volatile media, removable and non-removable media.

System memory 228 can include computer system readable media in the form of volatile memory, such as random access memory (RAM) 230 and/or cache memory 232. Computer system 200 may further include other removable/non-removable, volatile/non-volatile computer system storage media. By way of example only, storage system 234 can be provided for reading from and writing to a non-removable, non-volatile magnetic medium (not shown, which may include a “hard drive” or a Secure Digital (SD) card). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 242, may be stored in memory 228 by way of example, and not limitation, as well as an operating system, one or more application programs, other program modules, and program data. Each of the operating system, the one or more application programs, the other program modules, and the program data or some combination thereof, may include an implementation of a networking environment. Program modules 242 generally carry out the functions and/or methodologies of embodiments of the invention as described herein.

Computer system 200 may also communicate with one or more external devices 214 such as a keyboard, a pointing device, an image capturing device, a video image capturing device, one or more displays 224, one or more devices that enable a user to interact with computer system 200, and/or any devices (e.g., network card, modem, etc.) that enable computer system 200 to communicate with one or more other computing devices. Such communication can occur via Input/Output (I/O) interfaces 222. Still yet, computer system 200 can communicate with one or more networks such as a local area network (LAN), a general wide area network (WAN), and/or a public network (e.g., the Internet) via network adapter 220. As depicted, network adapter 220 communicates with the other components of computer system 200 via bus 218. It should be understood that, although not shown, other hardware and/or software components could be used in conjunction with computer system 200. Examples, include, but are not limited to: a microphone, one or more speakers, microcode, device drivers, redundant processing units, external disk drive arrays, RAID systems, tape drives, and data archival storage systems, etc.

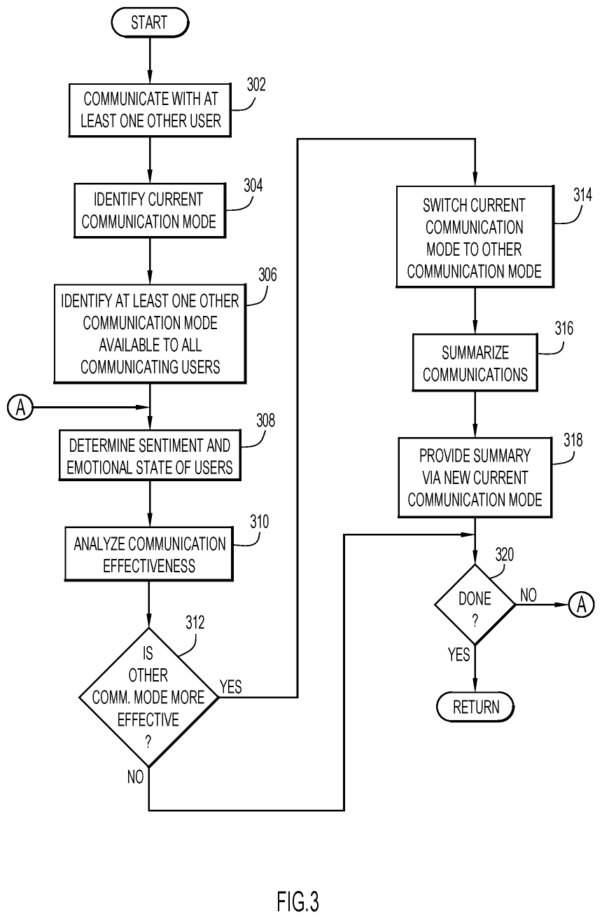

FIG. 3 is a flowchart illustrating an example process that may be performed in various embodiments. The process may be performed by user device 106, 108, server 104, or a combination of user devices 106, 108 and server 104. The process may begin with a communication from a user to at least one other user (act 302). The communication may be a video communication, a voice communication or a textual communication, which may include, but not be limited to, any of a phone call, email, a text message, and a video chat.

Next, the process may identify a current communication mode (act 304) and at least one other communication mode that is available to all users participating in the communication session (act 306). A sentiment and an emotional state of the users may then be determined (act 308).

Communication effectiveness of the communication mode may then be determined (act 310). In some embodiments, the communication effectiveness may be determined based on a sentiment and an emotional state of one or more users participating in the communication session, a determined level of understanding of the one or more users, and historical information with respect to the one or more users. Details regarding how communication effectiveness may be determined is discussed at a later point in this specification.

The process may then determine whether any of the at least one other identified communication mode is likely to be more effective than the current communication mode (act 312). In some embodiments, the communication effectiveness of the at least one other identified communication mode may be determined based on historical information regarding the users participating in the communication as well as a determined subject matter of the communication.

If, during act 312, one of the at least one other communication mode is determined to be more effective than the current communication mode then the current communication mode of user devices of the users participating in the communication session may be switched to the one of the at least one other communication mode (act 314). In some embodiments, one or more communicating users may receive an indication suggesting a switch to the one of the at least one other communication mode. In such embodiments, the one or more communicating users may indicate acceptance of the suggestion before the switch occurs. In other embodiments, the communication mode may be automatically switched to the one of the at least one other communication mode.

After switching to the one of the at least one other communication modes, communications that previously occurred among the participating users may be summarized based on natural language processing (act 316) and may be provided to the participating users via the switched current communication mode (act 318). The provided summary may include an identifier to distinguish participating users from each other and to associate corresponding portions of the summarized communications with respective participating users who provided the corresponding portions.

After performing act 318 or after determining, during act 312, that none of the at least one other communication mode are more effective than the current communication mode, a determination may be made regarding whether the communication session has ended (act 320). If the communication has ended, the process is completed. Otherwise, the process may return to act 308 to repeat the determining of a sentiment and an emotional state of the one or more participating users.

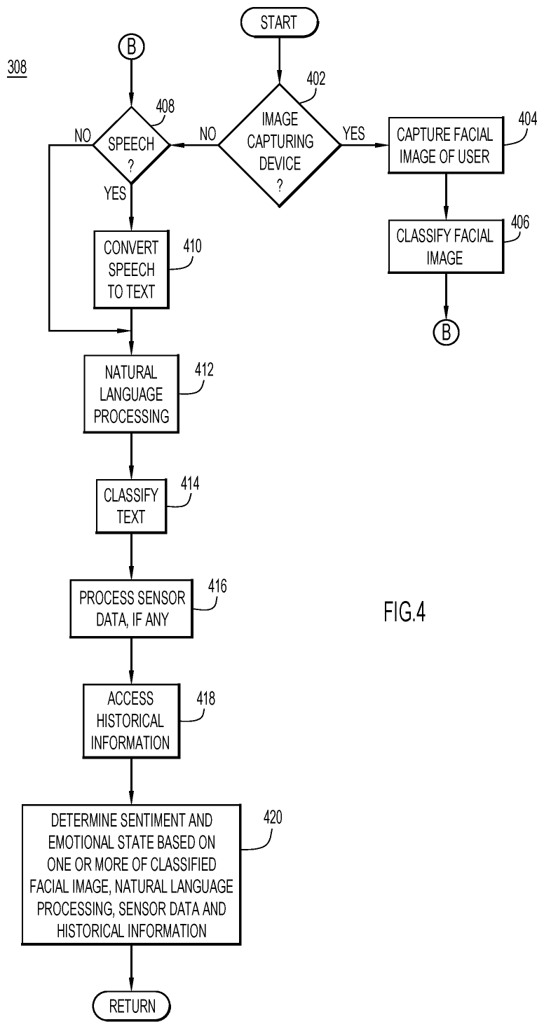

FIG. 4 is a flowchart that illustrates act 308 of FIG. 3 in more detail. The process may begin with a user processing device determining whether the user processing device includes an image capturing device (act 402). If the user processing device includes an image capturing device, then the image capturing device may capture a facial image of a user (act 404) and may classify the facial image (act 406). In some embodiments, the facial image may be classified as happy, nervous, upset, etc. based on facial features detected in the facial image. For example, a facial image with a smile may be classified as happy. A facial image having a wrinkled brow may be classified as concerned. A series of facial images with eyes looking away from the image capturing device may be classified as nervous. A facial image with a reddened face and tears may be classified as upset.

After classifying the facial image, or after determining that the user device does not include an image capturing device, a determination may be made regarding whether a communication is via speech (act 408). If the communication is determined to be via speech, then the speech may be converted to text (act 410).

After performing act 410 to convert the speech to text, or after determining, during act 408, that the communication is not via speech, natural language processing may be performed on textual input (act 412). The natural language processing may analyze the text and may classify the text based on a sentiment or tone of the text (act 414).

In some embodiments, sensor data may be provided by the user processing device. If so, the sensor data may be processed (act 416). For example, sensors may be provided in a user processing device to detect an amount of pressure a user applies to a keyboard to provide textual input. As another example, a video image capturing device included in a user processing device may capture a video image of hands of the user and may provide the video image for processing. The detected amount of pressure and/or the video image of the hands may be processed to determine whether the hands of the user are shaking, thereby indicating that the user is nervous or emotionally distraught. Similarly, natural language processing may determine whether provided speech input includes stuttering by a user, which may be an indication of nervousness.

Historical information regarding the user may be accessed (act 418). The historical information may indicate various situations, including communication modes, in which the user was and was not comfortable communicating via various communication modes.

The process may then determine a sentiment and an emotional state of the user based on one or more of the classified facial image, the natural language processing (which may analyze speech input from the user to detect any stuttering patterns), the sensor data and the historical information (act 420). The process may then be completed. In one embodiment, software available from iMotions, which has an office in Boston, Mass., may be used to determine the user's sentiment based on a facial image.

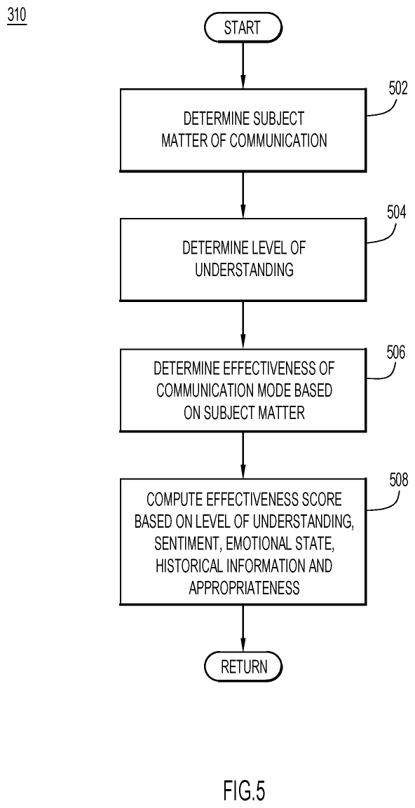

FIG. 5 is a flowchart of an example process for performing act 310 to analyze communication effectiveness of a communication session. The process may begin with determining a subject matter of a communication based on the natural language processing (act 502). Responses regarding the communication, from one or more other users, may be analyzed to determine a level of understanding of the one or more other users regarding the communication (act 504). For example, a response from the one or more other users that is determined to be inappropriate with respect to the determined subject matter may indicate that the one or more users did not understand the communication. As another example, a response from the one or more other users that indicate a lack of understanding such as “I don't know what you mean.”, “That doesn't make sense.”, “I am confused.”, or other similar remark may also indicate that the one or more users did not understand or misunderstood the communication.

The process may then determine whether the communication mode is effective for the subject matter (act 506). For example, if the user is attempting to describe a rash to a doctor via a textual communication mode such as, for example, email or text messaging, the textual communication mode may be considered to be not as effective as another available communication mode such as, for example, a video chat.

In a variation of this embodiment, a determination may be made regarding whether any data related to the determined subject matter is stored, and if so, the data may be sent to the at least one other user participating user in the communication. Using the example above, if an image of the rash is determined to be stored, a copy of the image may be sent to the doctor. In some embodiments, the user may be notified regarding the stored data and a copy of the stored data may not be sent without approval of the user.

The process may then compute a communication effectiveness score based on the determined level of understanding, the sentiment, the emotional state, historical information, and effectiveness with respect to the subject matter (act 506). The process may then be completed.

In some embodiments, the communication effectiveness score may be calculated according to (a×Lu)+(b×S)+(c×Es)+(d×H)+(e×Ecm), where Lu is a numerical value indicating a level of understanding of the user, S is a numerical value indicating a sentiment of the user, Es is a numerical value indicating an emotional state of the user, H is a numerical value indicating a level of comfort a user has had, historically, with the communication mode, Ecm is a numerical value indicating an effectiveness of the communication mode based on a determined subject matter, and a through e may be defined coefficients such that a maximum communication effectiveness score may be 100% and a minimum communication effectiveness score may be 0%. Other methods may be used in other embodiments to calculate a communication effectiveness score.

The coefficients in the above formula may be determined based on data collected from users' experiences in various contexts including, but not limited to, medical, personal, work related, etc. and for various communication channels. In one embodiment, the coefficients may be calculated by applying supervised machine learning algorithms to collected data. The coefficients may then be adjusted based on experiences of a particular user.

Once a user's communication patterns are learned, a determination may be made that, for example, the user is very confident speaking over a phone but is not confident when using video to talk to colleagues.

In other embodiments, analyzing communication effectiveness may give more weight to the sentiment and the emotional state of one user over one or more other users participating in the communication session based, at least partly, on which user is determined to better understand the communication and the determined subject matter. Different embodiments may give more weight to the sentiment and the emotional state of one user over one or more other users participating in the communication based, at least partly, on other factors.

Some embodiments may use one or more machine learning techniques to find patterns regarding a user's comfort level regarding respective communication modes and various correlations among, for example, a user's sentiment, emotional state, communication mode, subject matter, etc.

Although, the above description describes calculating a communication effectiveness score based on information pertaining to a user, in some embodiments, a communication effectiveness score may be based on information pertaining to all users participating in the communication.

The computer or other processing systems employed by the present invention embodiments may be implemented by any number of any personal or other type of computer or processing system, such as a desktop, laptop, PDA, mobile devices, etc., and may include any commercially available operating system and any combination of commercially available and custom software. The software may include browser software, communications software, and server software). These systems may include any types of monitors and input devices, such as a keyboard, mouse, voice recognition, etc.), to enter and/or view information.

It is to be understood that the software of the present invention embodiments may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium, such as a LAN, WAN, Intranet, Internet, hardwire, modem connection, wireless, etc. For example, the functions of the present invention embodiments may be distributed in any manner among the various computer systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments may be available on a non-transitory computer useable medium, such as a magnetic or optical medium, magneto-optic mediums, floppy diskettes, CD-ROM, DVD, memory devices, etc., of a stationary or portable program product apparatus or device for use with stand-alone systems or systems connected by a network or other communications medium.

The communication network may be implemented by any number of any type of communications network, such as a LAN, WAN, Internet, Intranet, VPN, etc. The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media, such as local area network (LAN), hardwire, wireless link, Intranet, etc.

The system may employ any number of any conventional or other databases, data stores or storage structures (e.g., files, databases, data structures, data or other repositories, etc.) to store information. The database system may be implemented by any number of any conventional or other databases, data stores or storage structures to store information. The database system may be included within or coupled to server and/or client systems. The database systems and/or storage structures may be remote from or local to a computer or other processing systems, and may store any desired data.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figs. illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A machine-implemented method comprising:
identifying, by a computing device, a first communication mode being used by a user to communicate with at least one other user;
analyzing, by the computing device, communication effectiveness between the user and the at least one other user based, at least partly, on determining a sentiment and an emotional state of the user;
determining, by the computing device, a second communication mode available to the user and the at least one other user that is more effective than the first communication mode based on the analyzing;
switching the first communication mode to the second communication mode; and
providing, by the computing device, a summarized version of communications between the user and the at least one other user, the summarized version of the communications being provided via the second communication mode.

2. The machine-implemented method of claim 1, wherein the analyzing further comprises:
performing natural language analysis to determine whether information included in a communication between the user and the at least one other user is being understood by one of the user and the at least one other user receiving the communication.

3. The machine-implemented method of claim 1, further comprising:
receiving sensor input related to the user; and
determining the emotional state of the user based on the sensor input.

4. The machine-implemented method of claim 3, wherein the sensor input includes at least one of an image of a face of the user and pressure data related to use of keys by which the user provides textual input.

5. The machine-implemented method of claim 1, wherein:
the analyzing further comprises:
performing natural language analysis of a communication to determine a subject matter of the communication between the user and the at least one other user; and
the determining the second communication mode is further based on the determined subject matter of the communication.

6. The machine-implemented method of claim 5, further comprising:
determining that data related to the determined subject matter of the communication is stored; and
sending the stored data to the at least one other user.

7. The machine-implemented method of claim 5, wherein:
the natural language analysis further comprises:
determining that information included in a communication between the user and the at least one other user is not understood by one of the user and the at least one other user receiving the communication; and
the analyzing the communication effectiveness is further based on a sentiment and an emotional state of the at least one other user, the analyzing giving more weight to the sentiment and the emotional state of one of the user and the at least one other user based, at least partly, on which one of the user and the at least one other user is determined to better understand the communication and the determined subject matter of the communication.

8. The machine-implemented method of claim 1, wherein the determined sentiment of the user is based, at least partly on maintained historical information related to the user.

9. A computer system comprising:
at least one processor; and
a memory connected to the at least one processor, the memory having instructions recorded therein, such that when the at least one processor executes the instructions, the computing system performs a method comprising:
identifying a first communication mode being used by a user to communicate with at least one other user;
analyzing communication effectiveness between the user and the at least one other user based, at least partly, on determining a sentiment and an emotional state of the user;
determining a second communication mode available to the user and the at least one other user that is more effective than the first communication mode based on the analyzing;
switching the first communication mode to the second communication mode; and
providing a summarized version of communications between the user and the at least one other user, the summarized version of the communications being provided via the second communication mode.

10. The computer system of claim 9, wherein the analyzing further comprises:
performing natural language analysis to determine whether information included in a communication between the user and the at least one other user is being understood by one of the user and the at least one other user receiving the communication.

11. The computer system of claim 9, wherein the method further comprises:
receiving sensor input related to the user; and
determining the emotional state of the user based on the sensor input.

12. The computer system of claim 11, wherein the sensor input includes at least one of an image of a face of the user and pressure data related to use of keys by which the user provides input.

13. The computer system of claim 9, wherein:
the analyzing further comprises:
performing natural language analysis of a communication to determine a subject matter of the communication between the user and the at least one other user; and
the determining the second communication mode is further based on the determined subject matter of the communication.

14. The computer system of claim 13, wherein the method further comprises:
determining that data related to the determined subject matter of the communication is stored;
sending the stored data to the at least one user.

15. The computer system of claim 13, wherein:
the natural language analysis further comprises:
determining that information included in a communication between the user and the at least one other user is not understood by one of the user and the at least one other user receiving the communication; and
the analyzing the communication effectiveness is further based on a sentiment and an emotional state of the at least one other user, the analyzing giving more weight to the sentiment and the emotional state of one of the user and the at least one other user based, at least partly, on which one of the user and the at least one other user is determined to better understand the communication and the determined subject matter of the communication.

16. A computer program product comprising at least one computer readable storage medium having computer readable program code embodied therewith for execution on at least one processor of a computer device, the computer readable program code being configured to be executed by the at least one processor to perform:
identifying a first communication mode being used by a user to communicate with at least one other user;
analyzing communication effectiveness between the user and the at least one other user based, at least partly, on determining a sentiment and an emotional state of the user;
determining a second communication mode available to the user and the at least one other user that is more effective than the first communication mode based on the analyzing;
switching the first communication mode to the second communication mode; and
providing a summarized version of communications between the user and the at least one other user, the summarized version of the communications being provided via the second communication mode.

17. The computer program product of claim 16, wherein the analyzing further comprises:
performing natural language analysis to determine whether information included in a communication between the user and the at least one other user is being understood by one of the user and the at least one other user receiving the communication.

18. The computer program product of claim 16, wherein the computer readable program code is further configured to be executed by the at least one processor to perform:
receiving sensor input related to the user; and
determining the emotional state of the user based on the sensor input.

19. The computer program product of claim 18, wherein the sensor input includes at least one of an image of a face of the user and pressure data related to use of keys by which the user provides input.

20. The computer program product of claim 16, wherein:
the analyzing further comprises:
performing natural language analysis of a communication to determine a subject matter of the communication between the user and the at least one other user; and
the determining the second communication mode is further based on the determined subject matter of the communication.
